(19) United States
(12) Patent Application Publication
(10) Pub. No.: US 2026/0370749 A1
(43) Pub. Date: Nov. 19, 2026

(54) CALL HOLD DETECTION AND RETURN ASSISTANCE FOR ELECTRONIC DEVICES

(71) Applicant: Apple Inc., Cupertino, CA (US)

(72) Inventors: Mahak GOINDANI, Sunnyvale, CA (US); David S. EVANS, San Jose, CA (US); Gencer CILI, San Jose, CA (US); Jae Woo CHANG, Los Altos Hills, CA (US); Karthick SANTHANAM, Campbell, CA (US); Christopher M. GARRIDO, Santa Clara, CA (US)

(21) Appl. No.: 19/440,435

(22) Filed: Jan. 5, 2026

Related U.S. Application Data
(60) Provisional application No. 63/808,625, filed on May 19, 2025.
(60) Provisional application No. 63/808,626, filed on May 19, 2025.
(60) Provisional application No. 63/819,969, filed on Jun. 8, 2025.

(51) Int. Cl. H04M 1/72403; G10L 15/26; G10L 25/51

(52) U.S. Cl. CPC H04M 1/72403; G10L 15/26; G10L 25/51

(57) ABSTRACT

The subject technology enables detection of call hold states and transition assistance for electronic devices during telephony sessions. An electronic device may receive and analyze audio signals associated with a call session to determine a call state selected from multiple predefined states. Upon determining the call state, the device outputs a notification to trigger a modification of the user interface. When the call is identified as being in a hold state, a user interface transition is initiated to reflect this condition. A transition from a hold state to a live-agent state is also detected based on audio signal analysis, prompting an additional notification to the user. The system may further receive a telephone number linked to the call session and query a database of obfuscated telephone numbers associated with historical hold states. If a match is found, the device predicts a likely hold state and modifies the user interface accordingly.

### CROSS-REFERENCE TO RELATED APPLICATIONS

The present application claims the benefit of U.S. Provisional Application No. 63/808,625, entitled “CALL HOLD DETECTION AND RETURN ASSISTANCE FOR ELECTRONIC DEVICES”, filed May 19, 2025, U.S. Provisional Application No. 63/808,626, entitled “CALL HOLD DETECTION AND RETURN ASSISTANCE FOR ELECTRONIC DEVICES”, filed May 19, 2025, and U.S. Provisional Application No. 63/819,969, entitled “CALL HOLD DETECTION AND RETURN ASSISTANCE FOR ELECTRONIC DEVICES”, filed Jun. 8, 2025, all of which are incorporated herein for reference in their entirety.

### TECHNICAL FIELD

The present description relates generally to call management, and more particularly, for example, to call hold detection and return assistance for electronic devices.

### BACKGROUND

Call holds are a widely used communication feature to maintain a connection while delaying voice communication, due to agent unavailability in customer service environments, among other cases. Users are often subjected to extended wait times with limited feedback, requiring continuous monitoring of the call.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which call hold detection and return assistance may be implemented in accordance with one or more implementations.

FIG. 2 illustrates a schematic view of an electronic device for providing call hold detection and return assistance in accordance with one or more implementations.

FIG. 3 illustrates a schematic diagram showing an example of a user interface view for facilitating call hold detection and return assistance in accordance with one or more implementations.

FIG. 4 illustrates a flow diagram of an example process for determining a call hold state in accordance with one or more implementations.

FIG. 5 illustrates a flow diagram of an example process for transitioning presentation of a call session in a hold state in accordance with one or more implementations.

FIG. 6 illustrates a flow diagram of an example process for transitioning presentation of a call session in a live-agent state in accordance with one or more implementations.

FIG. 7 illustrates a flow diagram of an example process for predicting a call hold state in accordance with one or more implementations.

FIG. 8 illustrates an electronic system with which one or more implementations of the subject technology may be implemented.

FIGS. 9A and 9B illustrate example processes for application programming interface calls in accordance with one or more implementations.

FIGS. 10A and 10B illustrate an example device and system facilitating application programming interface calls in accordance with one or more implementations.

FIGS. 11A and 11B illustrate an example frame exchange facilitating application programming interface calls in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form to avoid obscuring the concepts of the subject technology.

Call holds may be used in telecommunication systems to temporarily suspend active voice communication while maintaining a connection between the calling and receiving parties. This call hold state may frequently occur in customer service environments, where calls are placed in a queue due to limited availability of human agents. During the hold period, callers may encounter pre-recorded messages or music while awaiting further interaction with a live human agent. The duration of the call hold state can vary sfignificantly depending on call volume, staffing, and service prioritization protocols. From a user perspective, maintaining active engagement during extended hold times can result in diminished productivity and degraded user experience. Call hold systems may often lack automation for user re-engagement, requiring manual monitoring of the call state.

Embodiments of the subject technology in the present disclosure provide for call hold detection and return assistance for electronic devices. In one or more implementations, the subject technology includes a hold assist feature that may operate by enabling an automated call assistant to monitor a call status of a call session initiated from an electronic device associated with a user while the user is disengaged from the call session in a hold state until a notification is provided to the user indicating that the hold state has ended. During the hold period, the user may be permitted to disengage from the call session and engage in unrelated activities. This may be beneficial in reducing the burden on the user during extended call hold periods, such as those encountered with customer service systems that may involve prolonged wait times.

The system can perform an assessment to determine whether a hold state is active and, upon confirmation, can monitor the call state to identify when the user can reengage. In one or more implementations, the subject technology also can include features for distinguishing between a live human agent and, for example, an automated advertisement system to determine a call state of the call session. For example, the system may access precompiled call directories of obfuscated telephone numbers associated with business entities likely to utilize such automated advertisement systems. Call return notifications also can be output to notify a transition from a hold state to a live-agent state for active reengagement by the user. In one or more other implementations, signaling components may be inserted into an audio uplink path to indicate an impending return of the user to the call session, which may reduce premature termination by the recipient of the call.

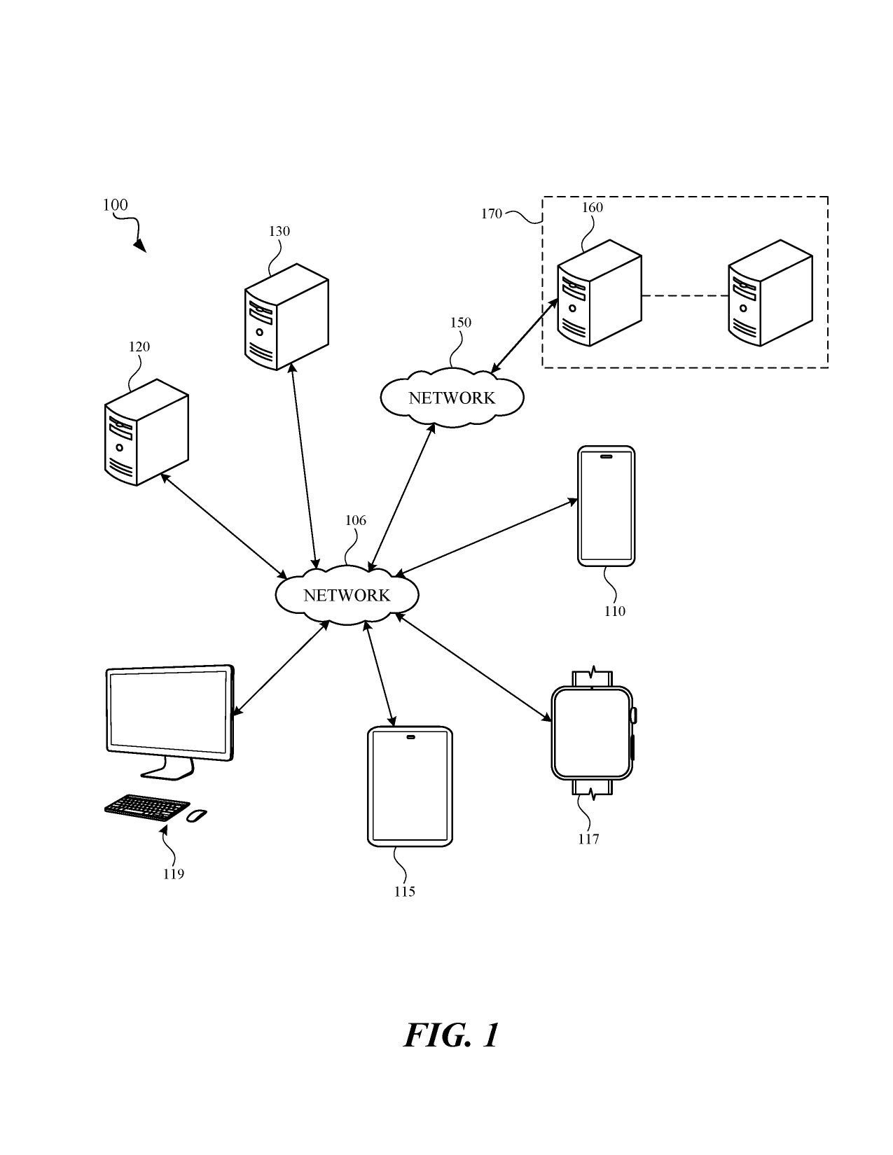

FIG. 1 illustrates an example network environment 100 in which call hold detection and return assistance may be implemented in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 115, an electronic device 117, an electronic device 119, a server 120, and a server 130. The network 106 may communicatively couple the electronic device 110, the electronic device 115, the electronic device 117, the electronic device 119, the server 120, and/or the server 130. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 115, the electronic device 117, the electronic device 119, the server 120, and the server 130; however, the network environment 100 may include any number of electronic devices and/or any number of servers communicatively coupled to each other directly or via network 106.

The server 160 may form all or part of a network of computers or a group of servers 170, such as in an access network implementation. For example, the server 170 stores data and software, and includes specific hardware (e.g., processors and other specialized or custom processors) for providing access to Internet protocol (IP) services, such as the Internet, an intranet, a streaming service, a cellular service, and/or other IP services. In an implementation, the group of servers 170 may function as part of a cellular service that provides wireless communications to the electronic device 110, the electronic device 115, the electronic device 117, and/or the electronic device 119. The network 150 may communicatively couple the group of servers 170 to the electronic device 110, the electronic device 115, the electronic device 117, the electronic device 119, the server 120, and/or the server 130 via the network 106. Although the network 106 and the network 150 are depicted as separate networks, these networks may form, and/or may include all or part of, a common network in other implementations.

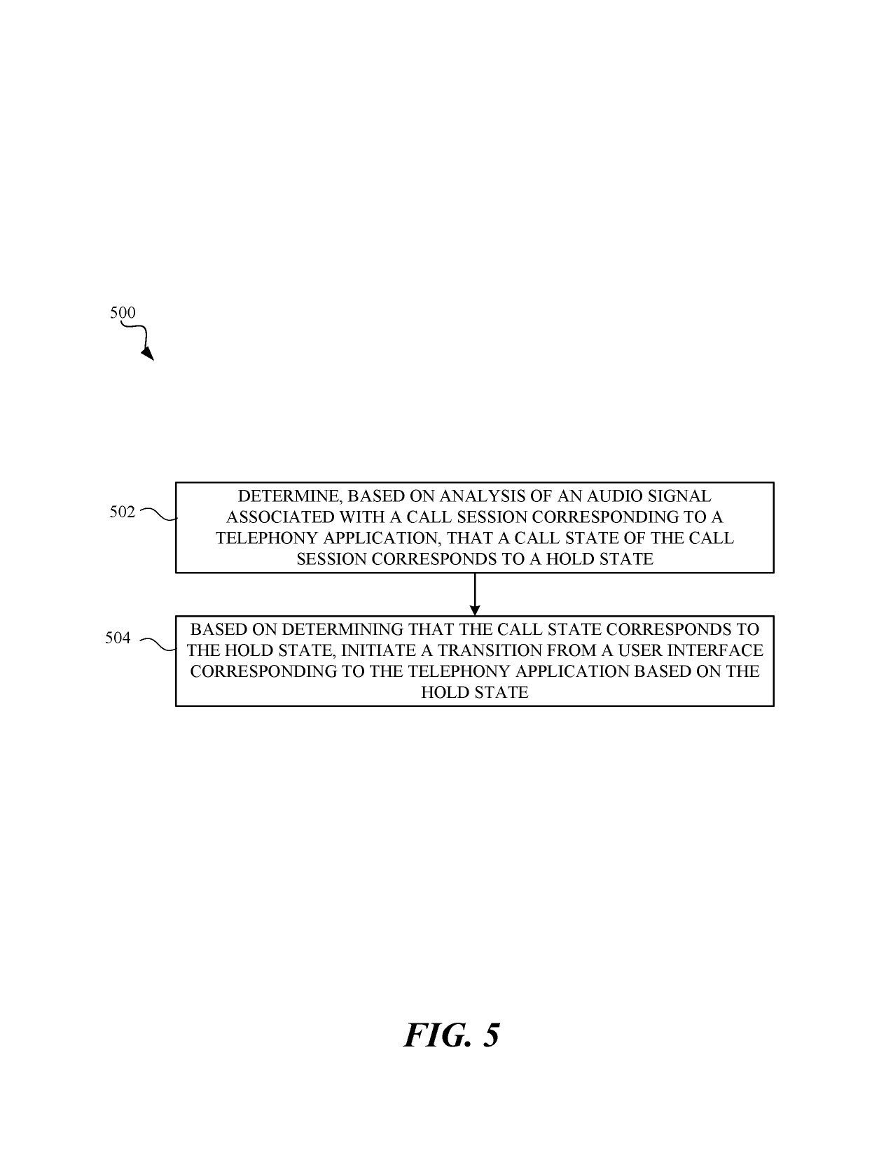

Any of the electronic device 110, the electronic device 115, the electronic device 117, or the electronic device 119 may be, for example, a desktop computer, a portable computing device such as a laptop computer, a smartphone, a peripheral device (e.g., a digital camera, headphones), a tablet device, standalone telephony hardware, a wearable device such as a watch, a band, and the like, or any other appropriate device that includes, for example, one or more wireless interfaces, such as WLAN radios, cellular radios, Bluetooth radios, Zigbee radios, near field communication (NFC) radios, and/or other wireless radios. Any of the electronic device 110, the electronic device 115, the electronic device 117, or the electronic device 119 may be, and/or may include all or part of, the electronic system discussed below with respect to FIG. 5.

In FIG. 1, by way of example, the electronic device 110 is depicted as a smart phone, the electronic device 115 is depicted as a tablet device, the electronic device 117 is depicted as a smart watch, and the electronic device 119 is depicted as a desktop computer. In one or more implementations, the electronic device 110, the electronic device 115, the electronic device 117, and/or the electronic device 119 may include a telephony application, a wait-on-hold service, and/or a transcription service installed and/or accessible at that electronic device. In one or more implementations, the electronic device 110, the electronic device 115, the electronic device 117, and/or the electronic device 119 may include a camera and/or a microphone and may provide the telephony application for exchanging audio streams, video streams, and/or transcriptions over the network 106, such as with a corresponding telephony application that is installed and accessible at, for example, one more others of the electronic device 110, electronic device 115, electronic device 117, and/or electronic device 119.

In one or more implementations, one or more of the electronic device 110, the electronic device 115, the electronic device 117, and/or the electronic device 119 may have a telephony application installed and accessible at the electronic device, and may not have a transcription service available at that electronic device. In one or more implementations, one or more of the electronic device 110, the electronic device 115, the electronic device 117, and/or the electronic device 119 may not have a telephony application installed and available at that electronic device, but may be able to access an electronic call session without the telephony application, such as via a web-based telephony application provided, at least in part, by one or more servers.

In one or more implementations, one or more servers such as the server 120 and/or the server 130 may perform operations for managing secure exchange of audio streams and/or video streams between various electronic devices such as the electronic device 110, the electronic device 115, the electronic device 117, and/or the electronic device 119, such as during a call session (e.g., an audio voice call session or a video voice call session). In one or more implementations, the server 120 may store account information associated with the electronic device 110, the electronic device 115, the electronic device 117, the electronic device 119, and/or users of those devices. In one or more implementations, one or more servers such as the server 130 may provide resources (e.g., web-based application resources), for managing connections to and/or communications within the call session. In one or more implementations, one or more servers such as the server 130 may store information indicating one or more capabilities of the electronic devices that are participants in a call session, such as device call assist capabilities of the participant devices and/or other device capability information.

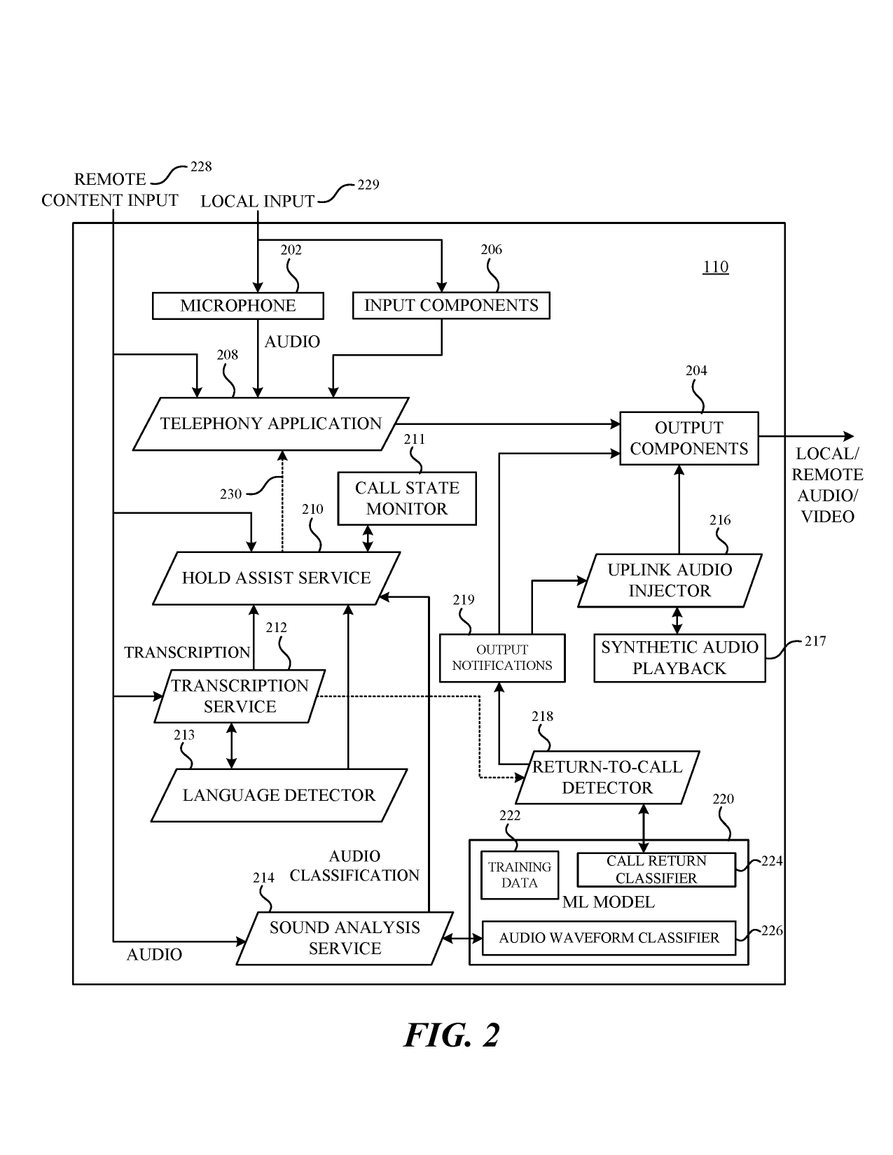

FIG. 2 illustrates a schematic view of an electronic device 110 for providing call hold detection and return assistance in accordance with one or more implementations. In the example of FIG. 2, rectangular boxes are used to indicate hardware components, and trapezoidal boxes are used to indicate software processes that may be executed by one or more processors of the electronic device.

As shown in FIG. 2, an electronic device, such as electronic device 110, may include one or more microphones such as microphone 202, and output components 204 (e.g., a display and/or one or more speakers). FIG. 2 also illustrates a hold assist service 210, a transcription service 212, a language detector 213, a sound analysis service 214, an uplink audio injector 216, and a return-to-call detector 218, that may be installed and/or running at the electronic device 110. In the example, of FIG. 2, the transcription service 212 is shown separately from the hold assist service 210 (e.g., as a system process at the electronic device 110). However, in other implementations, the transcription service 212 may be provided as a part of the hold assist service 210. For example, in one or more other implementations, the transcription service 212 may be provided as a part of the sound analysis service 214.

FIG. 2 also shows input components 206 to receive input from a user of the electronic device 110. For example, the electronic device 110 can provide input options such as a call hold option (e.g., to perform at least one of minimizing a screen display of a telephony application running on the electronic device 110 or silencing an audio output associated with the call session).

FIG. 2 also illustrates a telephony application 208 running at the electronic device 110. In the example, of FIG. 2, the hold assist service 210 is shown separately from the telephony application 208. However, in other implementations, the hold assist service 210 may be provided as part of the telephony application 208. The telephony application 208 may refer to the capability of the electronic device 110 to make and receive voice calls, send and receive text messages, and access various communication features. The telephony application 208 can utilize built-in cellular network connectivity of the electronic device 110, allowing users to establish real-time voice communication with other devices through traditional phone calls or IP services like Voice over IP (VoIP). Additionally, the telephony application 208 can enable text-based communication through SMS (Short Message Service) or other messaging applications. The telephony application 208 can provide an audio output corresponding to the audio stream and/or a video output corresponding to the video stream for output via the output components 204 (e.g., the audio stream being output via an output device such as one or more speakers of, or connected to, the electronic device 110 and/or the video stream being output via a display device of the electronic device 110).

In one or more other implementations, the telephony application 208 may be a third-party application that can provide phone call functionality, including, for example, third-party phone dialers or communication applications. The third-party application may be provided access to the hold assist service 210 through an application programming interface (API) that may enable external applications to invoke or interact with the hold assist service 210. The hold assist service 210 may be exposed conditionally to the API based on system-level permissions, user preferences, or verified application credentials. Access control mechanisms can be employed to restrict or manage API availability based on application type, operating system policies, or other predefined security criteria.

As shown in FIG. 2, local input 229 (e.g., audio input to the microphone 202) may be received by the telephony application 208 running on the electronic device 110. For example, the user of the electronic device 110 may speak into the microphone 202.

In one or more implementations, the hold assist service 210 may act as an automated call assistant by monitoring incoming calls and/or outgoing calls on behalf of the electronic device 110. The hold assist service 210 receive an audio signal associated with a call session via the telephony application 208. The hold assist service 210 may analyze the audio signal to determine a call state of a plurality of call states of the call session. The hold assist service 210 may cause output of a notification to change a user interface of the electronic device 110 based on the determined call state.

In one or more other implementations, the hold assist service 210 may determine, based on analysis of an audio signal associated with a call session corresponding to the telephony application 208, that a call state of the call session corresponds to a hold state. The hold assist service 210 may, based on determining that the call state corresponds to the hold state, initiate a transition from a user interface corresponding to the telephony application 208 based on the hold state.

In one or more other implementations, the hold assist service 210 may determine, based on analysis of an audio signal associated with a call session, that a call state of the call session has transitioned from a hold state to a live-agent state. The hold assist service 210 may cause output of a notification signal to a user indicating a transition to the live-agent state.

In one or more other implementations, the hold assist service 210 may receive a telephone number associated with a call session. The hold assist service 210 may query a database that includes records of obfuscated telephone numbers previously identified as initiating hold states in call sessions. The hold assist service 210 may determine, based on a match between the telephone number associated with the call session and at least one of the obfuscated telephone numbers, that the call session is likely to enter a hold state. The hold assist service 210 may cause output of a notification to change a user interface of the electronic device 110 based on the call session being predicted to transition into the hold state. The telephone numbers may be obfuscated, for example, by using one or more bloom filters or one or more hashing algorithms.

As shown in FIG. 2, the hold assist service 210 may receive remote content input 228 (e.g., remote audio content and/or remote video content) from one or more other electronic devices, such as the electronic device 115, the electronic device 117, and/or the electronic device 119, during a call session. The hold assist service 210 can include one or more learning-based and/or non-learning-based models for perceiving, synthesizing, and inferring information. Persons skilled in the art will appreciate that the hold assist service 210 can include any suitable number of hold assist service 210 processes to generate output 230 based on the remote content input 228.

Persons of ordinary skill in the art will appreciate that the hold assist service 210 can include any suitable machine learning models that are well-known or widely available such as regression techniques, classification techniques, neural networks, and deep learning networks. Additionally or alternatively, persons of ordinary skill in the art will appreciate that the hold assist service 210 can be any suitable non-learning processes such as rule-based systems, heuristics, decision trees, knowledge-based systems, statistical or stochastic systems, and expert systems.

In instances where the hold assist service 210 is a machine-learning based model, the hold assist service 210 can be trained to classify a call state using one or more well-known or widely available training techniques such as supervised learning, semi-supervised learning, unsupervised learning, and/or reinforcement learning techniques.

FIG. 2 also illustrates how, in some operational circumstances in one or more implementations, remote content (e.g. an audio stream from one or more other electronic devices, such as the electronic device 115, the electronic device 117, and/or the electronic device 119 during a call session) is provided to the transcription service 212. In one or more implementations, the transcription service 212 can generate a transcription of the audio portion of the remote content input 228, and provide the transcription of the audio portion of the remote content input 228 for analysis by the language detector 213 (e.g. detect spoken language in the received remote content input 228). In one or more implementations, the transcription can be provided to the return-to-call detector 218 for determining whether the hold state of the call session has ended and whether the user should return and reengage with the call session.

In one or more implementations, the transcription service 212 may also provide the transcription to the hold assist service 210. In one or more other implementations, the transcription can be generated by the hold assist service 210 (e.g., the transcription service 212 may be implemented as an integral part of the hold assist service 210). In one or more implementations, the transcription can be displayed in real-time on the electronic device 110 (or at least concurrently with the call session). The transcription may be generated and transmitted in segments, so that each segment of the transcription can be displayed at the electronic device 110 as the corresponding audio input is being provided to the electronic device 110. The transcription service 212 or the hold assist service 210 may generate time information for the transcription. The time information can be used to synchronize the transcription with the remote content input 228 audio/video when the remote content input 228 audio/video and the transcription are rendered at the electronic device 110. For example, a time at which the transcription (or a segment thereof) was generated, or a time at which the transcribed audio input (or a segment thereof) was provided for display at the electronic device 110 can be provided along with a time at which an audio stream (or a segment thereof) of the remote content input 228 is received at the electronic device 110, and the time corresponding to the transcription and the time corresponding to the audio input can be used to synchronize the transcription and the corresponding audio stream in which a user speaks the words in the transcription.

As illustrated in FIG. 2, the transcription service 212 may use local voice data to aid in generating a transcription of an audio portion of the remote content input 228 in one or more implementations. For example, the local voice data may include one or more stored and/or learned attributes (e.g., frequency characteristics, commonly used words or phrases, and/or voice models at the electronic device 110 that have been trained on voice inputs from the user of the electronic device 110 and/or a user of the electronic device 110, the electronic device 115, and/or the electronic device 117) of the voice of the user of the electronic device 110 and/or the user of the electronic device 110, the electronic device 115, and/or the electronic device 117. In this way, the transcription service 212 at the electronic device 110 may leverage its own preexisting knowledge of the user of the electronic device 110 and/or a user of the electronic device 110, the electronic device 115, and/or the electronic device 117 to generate transcriptions of spoken input by that user that are higher quality than would be otherwise possible by a general transcription service for generic voices (e.g., a transcription service provided by a server or another device of another user).

As illustrated, the electronic device 100 includes training data 222 that is stored in memory of the electronic device 100 for training a machine learning model. In one or more other implementations, the training data 222 includes data captured via at least one of the electronic devices 110-119, such as the electronic device 110. In an example, the server 120 (FIG. 1) may utilize one or more machine learning algorithms that uses the stored training data 222 for training a machine learning (ML) model 220. The ML model 220 can be trained to classify a call state, such as a hold state or a call return state, using one or more well-known or widely available training techniques such as supervised learning, semi-supervised learning, unsupervised learning, and/or reinforcement learning techniques.

Persons of ordinary skill in the art will appreciate that ML model 220 can include any suitable machine learning models that are well-known or widely available such as regression techniques, classification techniques, neural networks, and deep learning networks. For example, the ML model 220 may include one or more neural networks such as Artificial Neural Network (ANN), Convolutional Neural Network (CNN), Recurrent Neural Network (RNN), Adversarial Network (GAN), Reinforcement Learning Model (RLM), Encoder/Decoder Networks, and/or Transformer-Based Models (e.g., Bidirectional Encoder Representations from Transformers (BERT), Generative Pre-trained Transformer (GPT), and/or a multi-modal large language model (LLM)).

The ML model 220 also may include a call return classifier 224 and an audio waveform classifier 226. The training data 222 can be used to produce a machine learning model (e.g., call return classifier 224) that is trained to predict a hold state in a call session has ended and the call session has transitioned to a live-agent state. The training data 222 also can be used to produce a machine learning model (e.g., audio waveform classifier 226) that is trained to predict the type of audio being heard in a call session as either music or human agent speech, for example, to help determine the call state of the call session.

In one or more implementations, the sound analysis service 214 utilizes audio signal features such as the presence of music or silence to infer a remote call state. The call return classifier 224, within the ML model 220, may be employed to evaluate whether these audio features satisfy empirically defined criteria. If the criteria are met, the call state monitor 211 determines that the call session is likely in an on-hold state. In response, the output notifications module 219 conditionally generates a signal to modify the user interface of the electronic device 110, electronic device 115, electronic device 117, or electronic device 119, displaying an interface element prompting transition to an assisted hold mode. This decision-making process is based on signal analysis rather than predetermined caller metadata, such as telephone number prefixes, enabling a generalizable mechanism for detecting hold conditions without reliance on static rule sets.

In one or more implementations, the sound analysis service 214 categorizes speech audio into distinct classes, such as advertisements and user-generated speech. This categorization can be conducted by analyzing the audio data and distinguishing between speech patterns associated with advertising content and those arising from user interaction. The call return classifier 224, operating within the ML model 220, can apply predefined classification criteria to delineate between these categories. This can facilitate identifying advertisement content independently from user speech during operation of the telephony application 208.

In one or more implementations, the hold assist service 210 manages the call session by transitioning the user through various call states recorded by the call state monitor 211, as determined by the call return classifier 224. When the telephony application 208 identifies that the user has been placed on hold, the output notifications module 219 can display a prompt on the user interface of the electronic device 110. Upon user selection, a “wait on hold” function may be activated. Subsequently, the call session enters a screening mode in which the local and remote audio paths are muted to preserve privacy. During this mode, the transcription service 212 performs speech-to-text transcription of the remote content input 228. Concurrently, the language detector 213 can classify the spoken language, and the language detector 213 can be queried to validate whether the identified language is supported.

If the conditions are met, the transcription is processed by a text classifier to determine if the user should return to the call. Once a return to the call is detected, the screening mode is disabled, allowing audio communication to resume between the user and the remote agent. Notifications are provided to the user in the form of a “wing back” notification to alert the user when to return to the call.

If the specified conditions are satisfied, the transcription generated by the transcription service 212 can be processed by the call return classifier 224 within the ML model 220 to determine whether the user should resume participation in the call session. Upon detection by the return-to-call detector 218 that the user should return, the screening mode is deactivated, and bidirectional audio communication between the user and the remote agent can be restored. A corresponding notification is generated by the output notifications module 219 to inform the user of the appropriate time to return to the call.

In scenarios involving concurrent call sessions, the hold assist service 210 can facilitate that any incoming call is deferred until the current call session, managed by the telephony application 208, is terminated. If the user is already placed on hold, additional incoming calls are automatically rejected to prevent the user from being held in multiple simultaneous call sessions. When the user is prompted by the output notifications module 219 to resume the call, a notification is also transmitted to the remote agent, indicating that the user has re-engaged with the session through the hold assist feature, avoiding unintended disconnection by the remote party.

The sound analysis service 214, in conjunction with the audio waveform classifier 226, performs classification of audio signals received during the call session to determine the remote call status. The classification distinguishes between audio features indicative of hold conditions—such as background music or silence—from those associated with live human speech. This classification is performed using the ML model 220, which has been trained on customized data sets and processed through feature engineering techniques to improve classification accuracy. The use of the ML model 220 enables more granular state transitions and improves the responsiveness of the system in determining whether the user should be notified of a state change or remain in the hold state. In one or more other implementations, sound analysis can be performed with the sound analysis service 214 after the hold assist service 210 has been enabled to determine whether a song continues to play. This additional sound analysis mitigates any unnecessary transmission of song lyrics to the text classifier and avoids the premature triggering of a return to a call return state while background music playback is ongoing.

The hold assist service 210 is configured to support both outgoing and incoming call sessions initiated or received through the telephony application 208. In the case of an outgoing call, the process may begin when the user initiates a call and is subsequently placed on hold. For incoming calls, the system also applies when a vendor or service provider places the user on hold, optionally with a callback mechanism. Upon receiving a callback, the call may resume without immediate participation from a live agent, often accompanied by continued playback of hold media or silence. The call return classifier 224, operating within the ML model 220, may not rely solely on the detection of live-agent presence. Instead, audio classification may be used to determine whether user attention is beneficial. Examples may include prompts such as “Please enter the first four digits of your credit card number” or “Press one to request a callback,” indicating that user input is needed. User attention is determined to be beneficial under two conditions: (i) when a live human agent begins speaking, or (ii) when structured prompts requiring user interaction—such as dual-tone multi-frequency (DTMF) tones or voice responses—are identified.

The hold assist service 210 may initiate detection of on-hold states for both outgoing and incoming call sessions managed through the telephony application 208. Activation of the hold detection feature may occur either manually via a user interface control displayed on the electronic device 110, or automatically upon establishment of the call session. In automatic mode, the sound analysis service 214 can begin analyzing audio immediately upon call connection to identify an on-hold state. This detection can be performed in real time via continuous audio stream monitoring and may not require user input.

In one or more implementations, the sound analysis service 214, in coordination with the audio waveform classifier 226, may evaluate downlink audio content on a word-by-word basis. This can enable rapid differentiation between content types, such as advertisements and human dialogue. The accelerated classification process allows the output notifications module 219 to initiate notification playback promptly following the conclusion of remote speech, reducing latency and increasing the likelihood of maintaining call continuity. The use of an aggressive notification strategy by the hold assist service 210 can help reduce occurrences of call termination attributable to user-perceived system inactivity.

In one or more implementations, the hold assist service 210 determines whether user attention is warranted during a hold state by processing downlink audio through the audio waveform classifier 226, implemented within the ML model 220. The audio waveform classifier 226 can evaluate speech data transcribed by the transcription service 212 and can predict whether user attention is beneficial. This process can be performed automatically without user interaction. For example, when a call is placed through the telephony application 208 to an external entity such as a financial institution, the sound analysis service 214 can monitor the downlink audio in real time and classify its content for conditions that justify user re-engagement.

In one or more implementations, the decision-making process executed by the hold assist service 210 can be enhanced through analysis of user behavior history or previously observed interaction patterns. For example, if the call state monitor 211 identifies that a user routinely engages with a specific organization, such as a telecommunications provider, the hold assist service 210 may preemptively activate hold assist functionality without requiring a user prompt. Historical preferences, such as choosing to remain on hold or opting for a callback, may be stored and indexed to inform future automated actions by the telephony application 208 and output notifications module 219.

In one or more implementations, the hold assist service 210 may detect potential on-hold scenarios by analyzing multiple forms of input. For example, the sound analysis service 214 can perform audio evaluation to determine whether prompting the user with actions such as placing the call on hold is beneficial. In one or more other implementations, detection may not be limited to audio signals such that additional indicators, including user interaction with interactive voice response (IVR) menus via keypad input on the electronic device 110, can be utilized. For example, when a user presses keys such as “1” for customer support, the hold assist service 210 may interpret this behavior as navigation through an automated call tree, which may indicate an impending hold state. These forms of interaction can be incorporated by the hold assist service 210 to enhance the accuracy of determining whether to prompt the user to initiate a hold assist operation.

In one or more other implementations, an extended use case includes automatic engagement with IVR systems utilizing a separate classification model executed by the ML model 220, configured to interpret and respond to audio prompts such as “press 1 for sales” or “press 9 to speak with an agent.” This model can interpret menu options and trigger corresponding DTMF input via the uplink audio injector 216 on behalf of the user. Upon completion of IVR navigation, the hold assist service 210 may automatically initiate its functionality. In one or more other implementations, the hold assist service 210 may perform a fully automated call management sequence, in which, upon receiving a voice command (e.g., “call customer service”), the telephony application 208 performs end-to-end automation of dialing, IVR traversal, and hold state management. This may include identification and classification of relevant prompts via the sound analysis service 214, generation of appropriate responses, and activation of return-to-call procedures based on real-time analysis by the transcription service 212.

In one or more implementations, the audio waveform classifier 226, operating in conjunction with the sound analysis service 214, may continuously evaluate primary consecutive audio samples to assign classification labels such as music or silence, based on a threshold confidence level. Detection of a hold state can be initiated upon reaching a high-confidence classification indicating the user is on hold, enabling the hold assist service 210 to operate without user activation. Historical user interaction data may be recorded by the call state monitor 211, including prior use of hold assist features and DTMF input (e.g., selection of “9” for customer service), to improve decision quality.

In one or more other implementations, at the start of the hold assist operation, a user interface element such as a button is presented on the display of electronic device 110 to enable manual activation. In use cases where the user’s visual attention is constrained, such as when wearing wireless earbuds, driving, or holding the device to the ear, the output notifications module 219 may employ alternate modalities. These alternate modalities can include audio prompts requesting feature activation and haptic signals on compatible hardware. In one or more implementations, when a new incoming call is detected during an active hold assist session, the hold assist service 210 can be temporarily suspended, permitting the user to answer the new call while the previous session is maintained in an on-hold state. Upon return to the initial call, the hold assist feature can be re-enabled provided the remote party, as determined by the return-to-call detector 218, has not resumed interaction.

The sound analysis service 214, assisted by the audio waveform classifier 226, may function to detect on-hold conditions by evaluating the audio environment for indicators such as hold music. Upon confirming a hold state, the output notifications module 219 can display an output notification notifying the user of the detected condition. Subsequently, the sound analysis service 214 can be deactivated to conserve processing resources and reduce power consumption, particularly on battery-powered devices such as the electronic device 110. If the user interacts with the output notification without activating the hold assist feature, no further audio classification may be performed. In one or more other implementations, if the remote party resumes communication while the hold assist remains inactive, the hold assist service 210 may not detect this transition, although the call session audio continues uninterrupted.

In one or more implementations, the language detector 213 is associated with separate language models aligned with specific language families and may dynamically transition between these language-specific language models, such as those for Latin-script languages or Japanese language, based on user-defined configuration parameters or device-selected locale settings on electronic device 110.

In one or more implementations, dynamic switching between the language-specific language models can be performed based on user-selected settings and may not be triggered through real-time detection during the call session. In one or more implementations, the language detector 213 can infer the spoken language of the remote call participant. In one or more other implementations, this spoken language inference may not control the selection logic for the active language model utilized during the call session. In the example, of FIG. 2, the language detector 213 is shown separately from the hold assist service 210. However, in other implementations, the language detector 213 may be provided as part of the hold assist service 210.

In one or more implementations, switching of the language-specific language model may be performed either through explicit configuration by the user or through inference based on metadata or detected locale information. This configuration allows for language model selection on the electronic device 110 to occur via either direct user input or indirect factors including system-detected call characteristics.

In one or more implementations, the inference may include analysis of telephony metadata, such as country codes or regional area codes, to identify the geographic destination of the call. For example, when a call destination is inferred to be in Germany, the hold assist service 210 may associate this data with the probable language spoken by the recipient and select an appropriate language model accordingly.

In one or more implementations, selection of the active language model for audio processing during a call session can be determined by the language configuration set on the electronic device 110. If the electronic device 110 is configured for English, an English language model is utilized. In one or more other implementations, when a call is initiated to a region in which a different language is spoken, such as Germany, and the language of the electronic device 110 is not aligned with the remote region (e.g., English set instead of German), certain language-specific functionalities may not be activated. In one or more other implementations, if the electronic device 110 is configured to German, the corresponding language model may be engaged, and associated features are enabled when communicating with a recipient in a German-speaking region.

In one or more implementations, upon detection by the hold assist service 210 that a user should resume engagement with an ongoing call session, current device usage context of the user may be considered by the return-to-call detector 218. If the electronic device 110 (e.g., the initiating mobile phone) is not in close proximity to the user, callback notifications can be transmitted to other user-associated devices, including but not limited to electronic device 115 (e.g., a wearable device), electronic device 117 (e.g., a tablet), or electronic device 119 (e.g., a desktop or laptop computer).

In one or more implementations, when a call session is initiated on the electronic device 110 and the user relocates to a different physical environment carrying only a secondary electronic device (e.g., electronic devices 115-117), call return notifications may be redirected to that secondary electronic device. Notification routing is based on evaluated proximity conditions and real-time connectivity status between the originating and secondary devices. Proximity detection can be performed through short-range communication protocols, such as Bluetooth or near-field communication (NFC), to evaluate whether a given secondary device resides within the user’s proximity. Upon triggering of a call return event, the call session may be resumed on any notified electronic device 115, electronic device 117, or electronic device 119 that resides within the proximity of the user. In this regard, call session continuity can be maintained across device transitions without user interaction with the electronic device 110.

In one or more implementations, the electronic device 110 may function as the coordination point for determining return call notification eligibility among secondary devices. If a secondary device such as electronic device 117 does not maintain an active short-range communication link (e.g., via Bluetooth) with the originating device (e.g., the electronic device 110), this secondary device may be excluded from notification. In one or more other implementations, if the electronic device 115 remains within communication range during user relocation, it continues to receive the call return notifications.

In one or more implementations, the hold assist service 210 is configured to simulate agent engagement by detecting specific audio sequences indicative of a live human agent returning to an active call state. Upon identifying utterances such as “Hello. How can I help you?”, an alert can be triggered to instruct the user to resume call participation.

In one or more implementations, the system architecture of the electronic device 110 may include multiple integrated components tasked with managing user interaction during a call session via continuous analysis of incoming audio signals. During call initiation, remote content input 228 from a remote agent endpoint can be monitored. If detected audio patterns include either silence or background music exceeding a predefined duration threshold (e.g., 30 seconds), the hold assist service 210 can classify the call session as being in a hold state. Upon classification, a user interface prompt, via output components 204, can be generated to provide the option of enabling monitored hold functionality.

Upon initiation of the hold state by a user through the telephony application 208, the hold assist service 210 initiates a transition from executing audio classification tasks managed by the sound analysis service 214 to activation of the transcription service 212. During the hold state, audio signals received from the remote endpoint are processed by the transcription service 212 to generate textual representations of the received audio input. These text outputs are evaluated by the call return classifier 224, which resides within the ML model 220 and is trained to recognize linguistic constructs indicative of live human agent engagement in customer service domains. The classifier is configured to detect representative utterances, including “Hello, how may I help you?” or “Thank you for holding, this is [agent name],” and determine whether the return-to-call conditions managed by the return-to-call detector 218 have been satisfied.

Upon classification by the return-to-call detector 218 indicating the presence of a live human agent, the output notifications module 219 generates a notification signal prompting the user to resume participation in the call session. If the user is returned to a hold state by the remote agent, the hold assist service 210 re-initiates the processing sequence including operations from the sound analysis service 214 and the transcription service 212, enabling a recurring evaluation cycle comprising transcription, classification by the ML model 220, and notification generation.

The decision to inject audio to the remote agent endpoint may be controlled by the call return classifier 224 within the ML model 220, configured to evaluate transcribed speech from the transcription service 212 for indicators of return-to-call triggers. Audio segments processed by the sound analysis service 214 can be further evaluated by the audio waveform classifier 226 to determine whether conditions such as the transition from music to speech or the presence of actionable verbal content warrant user re-engagement. In response, the output notifications module 219 can issue a prompt to the user, while the uplink audio injector 216 transmits a synthesized audio message from synthetic audio playback storage 217, such as “Please wait while I notify the user,” followed by a ringing tone. This uplink audio injection may serve to indicate call continuity to the remote party and reduce the risk of premature call termination.

In one or more implementations, the uplink audio injector 216 may inject a fixed, preconfigured audio message stored in the synthetic audio playback storage 217 to the remote agent endpoint to indicate that the user is expected to resume participation in the active call session. Following the message, a ringing tone may also be transmitted to the remote agent endpoint. This audio sequence can function to signal continued user presence and activity. The ringing tone may be directed to the remote party and intended to discourage premature call termination in the absence of an immediate verbal response.

In one or more implementations, if a call return notification is issued and no response is received from the user, the call session may remain active until one of two outcomes occurs: either the remote agent disconnects, resulting in call termination, or the remote agent re-queues the user. In the event of re-queuing, the call state monitor 211 may detect the updated call state, and the output notifications module 219 may provide updated notifications accordingly. In one or more other implementations, a feedback mechanism may be configured to monitor call states locally and re-engage the hold assist service 210 when a return to the hold state is detected, reactivating audio monitoring and transcription processes without requiring call session disconnection.

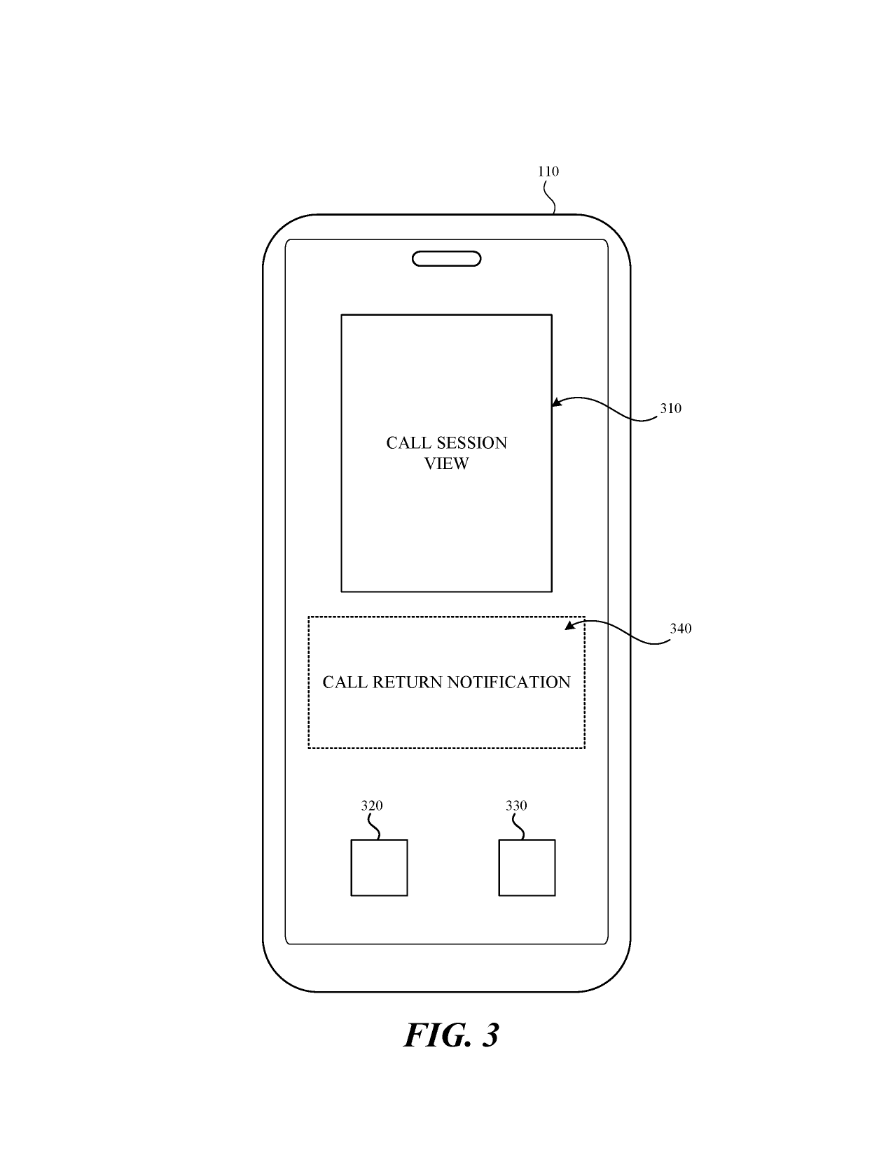

FIG. 3 illustrates a schematic diagram showing an example of a user interface view for facilitating call hold detection and return assistance in accordance with one or more implementations. As shown in FIG. 3, during a call session, the telephony application (e.., the telephony application 208 of FIG. 2) and/or hold assist service (e.g., the hold assist service 210 of FIG. 2) can provide, for display, a call return notification 340. In the example of FIG. 3, the dynamic presentation of the call return notification 340 is represented as a popup window on a display of the electronic device 110, for illustrative purposes. In the example of FIG. 3, a call session view 310 covers substantially the entire display of electronic device 110 with a portion being covered by the call return notification 340. However, this is merely illustrative and other arrangements of the call session view 310 and the call return notification 340 can be provided.

As shown in FIG. 3, the electronic device 110 may also provide an input option such as a screen display minimizing option 320 (e.g., for minimizing a screen display of the telephony application 208 running on the electronic device 110). In one or more implementations, the screen display of the telephony application 208 may be maximized and/or increased in surface area on a display of the electronic device 110 upon detection that the hold state has ended. Also shown in FIG. 3, the electronic device 110 may provide another input option such as a call session silencing option 330 (e.g., for silencing an audio output associated with the call session). In one or more implementations, upon return to the call session, the user may have the option to disable the silencing operation by interacting with the call session silencing option 330, activating the audio output associated with the call session. In one or more other implementations, the silencing operation may be automatically disabled (or turned off) upon the user reengaging with the call session.

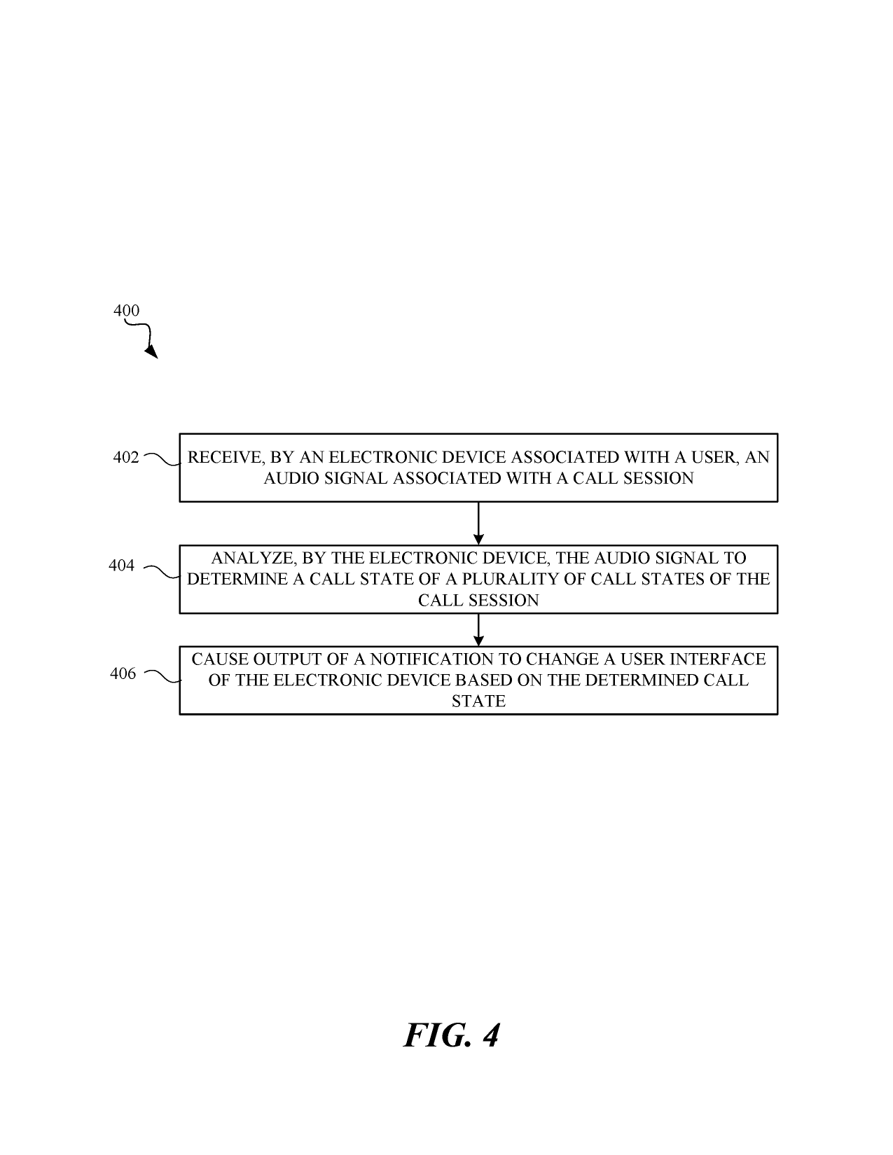

FIG. 4 illustrates a flow diagram of an example process 400 for determining a call hold state in accordance with one or more implementations. For explanatory purposes, the process 400 is primarily described herein with reference to the components of FIG. 1 (particularly with reference to electronic device 110), which may be executed by one or more processors of the electronic device 110 of FIG. 1. However, the process 400 is not limited to the electronic device 110, and one or more blocks (or operations) of the process 400 may be performed by one or more other components of other suitable devices, such as one or more of the electronic device 110, the electronic device 115, the electronic device 117, the electronic device 119, and/or one or more servers such as the server 120 and/or the server 130. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

In the example process 400, at block 402, a first device may receive an audio signal associated with a call session. In one or more implementations, the call session may be between the first device (e.g., electronic device 110) and a second device (e.g., one of electronic device 110, electronic device 115, or electronic device 117). In one or more other implementations, the call session may be between the first device (e.g., electronic device 110) and another electronic device associated with a remote agent endpoint (not shown).

In one or more implementations, as part of the audio signal analysis, the first device may transcribe spoken language in the audio signal into a transcribed text and classify the transcribed text using a machine learning classifier executed by the first device. In one or more implementations, the machine learning classifier can be configured to determine whether the spoken language is a pre-recorded message or speech uttered by a human agent associated with a remote agent endpoint. In one or more other implementations, the machine learning classifier can perform classification at a word-level granularity to enable accelerated state determination.

In one or more other implementations, as part of the audio signal analysis, the first device may evaluate successive periods of audio waveforms of the call session to detect an audio pattern comprising at least one of music or silence. The first device may identify the call state as a hold state based on the audio pattern.

In one or more other implementations, as part of the audio signal analysis, the first device may detect user input via one or more interactions with a keypad (e.g., input components 206 of FIG. 2) of the first device. The first device may analyze the one or more interactions with the keypad. The first device may determine that the user input is indicative of the user of the first device engaging with an automated call tree in the call session. In one or more implementations, the call state can be determined during traversal of at least in part the automated call tree.

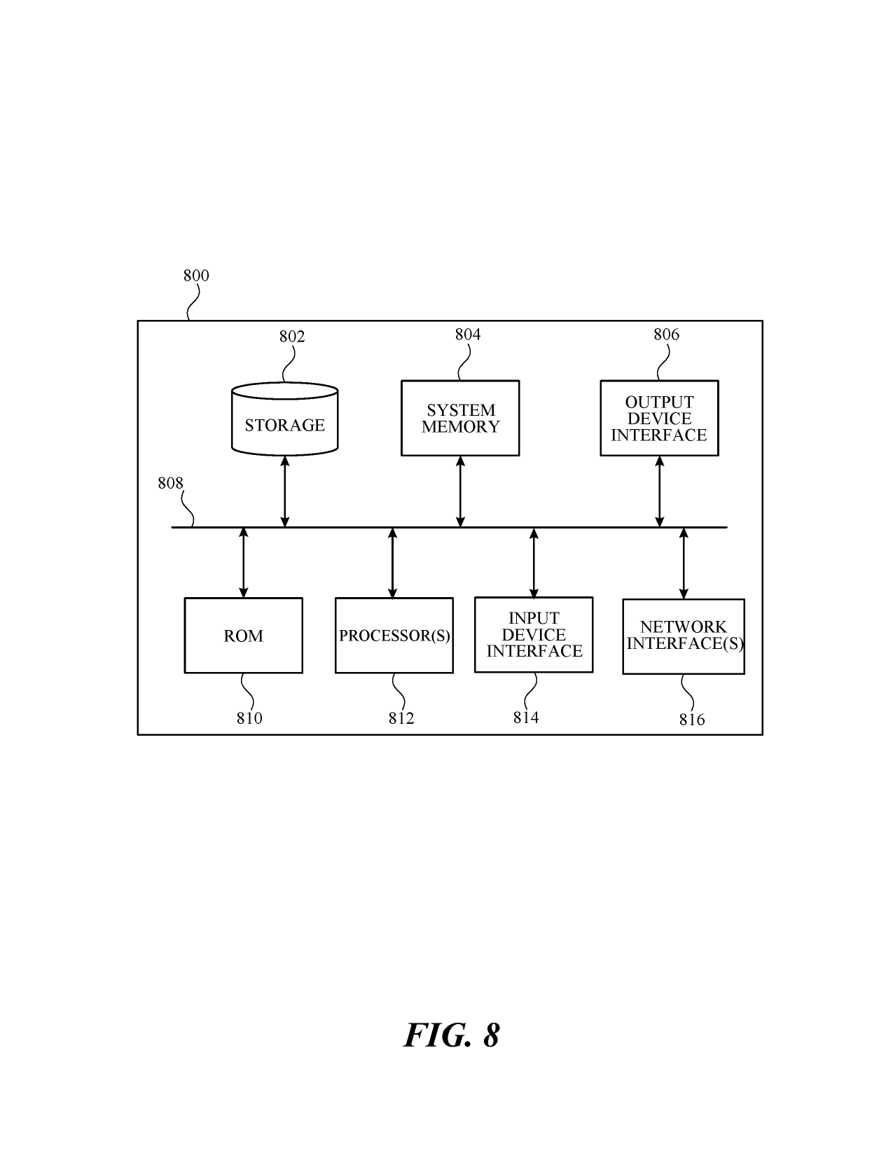

In one or more other implementations, the first device may access multiple language-specific language models stored in memory (e.g., permanent storage device 802 of FIG. 8) of the first device. The first device may select, prior to initiation of the call session, at least one of the language-specific language models based on user-configured language settings. The first device may execute the selected language-specific language model for real-time processing of speech data during the call session.

At block 404, the first device may analyze the audio signal to determine a call state of a plurality of call states of the call session.

At block 406, the first device may cause output of a notification to change a user interface of the electronic device based on the determined call state.

FIG. 5 illustrates a flow diagram of an example process for transitioning presentation of a call session in a hold state in accordance with one or more implementations. For explanatory purposes, the process 500 is primarily described herein with reference to the components of FIG. 1 (particularly with reference to electronic device 110), which may be executed by one or more processors of the electronic device 110 of FIG. 1. However, the process 500 is not limited to the electronic device 110, and one or more blocks (or operations) of the process 500 may be performed by one or more other components of other suitable devices, such as one or more of the electronic device 110, the electronic device 115, the electronic device 117, the electronic device 119, and/or one or more servers such as the server 120 and/or the server 130. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

In the example process 500, at block 502, a first device may determine, based on analysis of an audio signal associated with a call session corresponding to a telephony application (e.g., telephony application 208 of FIG. 2), that a call state of the call session corresponds to a hold state. In one or more implementations, the call session may be between the first device (e.g., electronic device 110) and a second device (e.g., one of electronic device 110, electronic device 115, or electronic device 117). In one or more other implementations, the call session may be between the first device (e.g., electronic device 110) and another electronic device associated with a remote agent endpoint (not shown).

At block 504, the first device may, based on determining that the call state corresponds to the hold state, initiate a transition from a user interface (e.g., output components 204; input components 206 of FIG. 2) corresponding to the telephony application based on the hold state. In one or more implementations, as part of the initiating the transition, the first device may prompt a user to perform at least one of minimizing a screen display of the telephony application running on the first device or silencing an audio output associated with the call session. In one or more other implementations, as part of the initiating the transition, the first device also may disable a subset of user interface elements (e.g., input components 206 of FIG. 2) associated with the call session until a transition from the hold state to a live-agent state is detected.

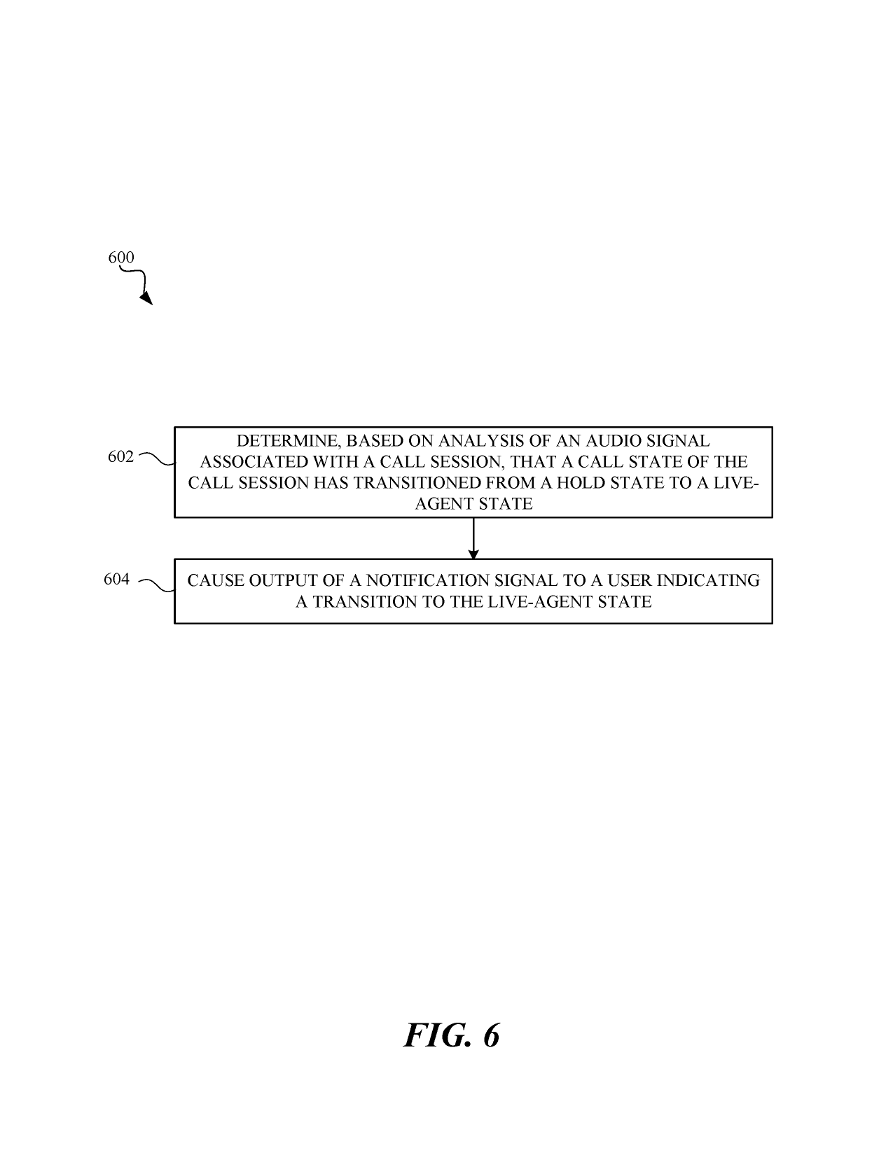

FIG. 6 illustrates a flow diagram of an example process for transitioning presentation of a call session in a live-agent state in accordance with one or more implementations. For explanatory purposes, the process 600 is primarily described herein with reference to the components of FIG. 1 (particularly with reference to electronic device 110), which may be executed by one or more processors of the electronic device 110 of FIG. 1. However, the process 600 is not limited to the electronic device 110, and one or more blocks (or operations) of the process 600 may be performed by one or more other components of other suitable devices, such as one or more of the electronic device 110, the electronic device 115, the electronic device 117, the electronic device 119, and/or one or more servers such as the server 120 and/or the server 130. Further for explanatory purposes, the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

In the example process 600, at block 602, a first device may determine, based on analysis of an audio signal associated with a call session, that a call state of the call session has transitioned from a hold state to a live-agent state. In one or more implementations, the call session may be between the first device (e.g., electronic device 110) and a second device (e.g., one of electronic device 110, electronic device 115, or electronic device 117). In one or more other implementations, the call session may be between the first device (e.g., electronic device 110) and another electronic device associated with a remote agent endpoint (not shown). In one or more other implementations, the first device may inject uplink audio indicating to a remote agent that the user is returning to the call session.

In one or more implementations, as part of the determining the transition to the live-agent state, the first device may transcribe speech within the audio signal. The first device may classify the transcribed speech using a machine learning classifier trained to distinguish human agents from automated messages. The first device also may identify the call state as the live-agent state based on output of the machine learning classifier.

At block 604, the first device may cause output of a notification signal to a user indicating a transition to the live-agent state. In one or more implementations, the notification signal is output to one or more secondary electronic devices (e.g., electronic devices 115-119 of FIG. 1) associated with the user that are located within a predefined proximity of the first device. In one or more implementations, the user may cease participation in the call session during at least in part the hold state. In this regard, the notification signal may include an audio message transmitted via an uplink channel to a remote agent endpoint, in which the audio message may indicate that the user is returning to the call session.

In one or more other implementations, the first device may access a database of obfuscated telephone numbers and determine a predicted hold state based on querying the database using an obfuscated telephone number associated with the call session.

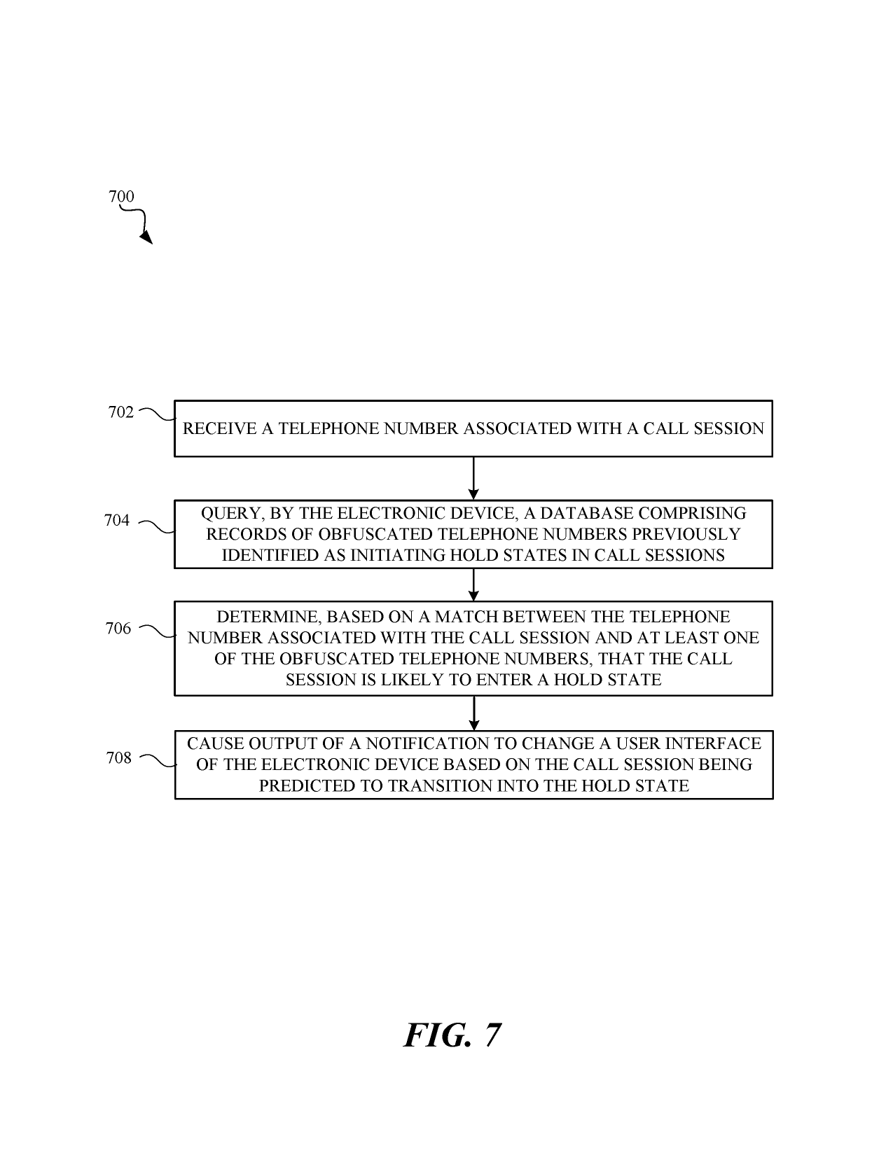

FIG. 7 illustrates a flow diagram of an example process for predicting a call hold state in accordance with one or more implementations. For explanatory purposes, the process 700 is primarily described herein with reference to the components of FIG. 1 (particularly with reference to electronic device 110), which may be executed by one or more processors of the electronic device 110 of FIG. 1. However, the process 700 is not limited to the electronic device 110, and one or more blocks (or operations) of the process 700 may be performed by one or more other components of other suitable devices, such as one or more of the electronic device 110, the electronic device 115, the electronic device 117, the electronic device 119, and/or one or more servers such as the server 120 and/or the server 130. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

In the example process 700, at block 702, a first device may receive a telephone number associated with a call session. In one or more implementations, the call session may be between the first device (e.g., electronic device 110) and a second device (e.g., one of electronic device 110, electronic device 115, or electronic device 117). In one or more other implementations, the call session may be between the first device (e.g., electronic device 110) and another electronic device associated with a remote agent endpoint (not shown).

At block 704, the first device may query a database comprising records of obfuscated telephone numbers previously identified as initiating hold states in call sessions. In one or more implementations, the database may be constructed over time by storing obfuscated telephone numbers associated with detected hold conditions.

At block 706, the first device may determine, based on a match between the telephone number associated with the call session and at least one of the obfuscated telephone numbers, that the call session is likely to enter a hold state.

At block 708, the first device may cause output of a notification to change a user interface of the electronic device based on the call session being predicted to transition into the hold state. In one or more implementations, the first device may, in response to a determination that the call session is in the hold state, cause a transition of presentation on the first device. The transition may include at least one of silencing audio output of the call session or minimizing a call interface associated with the call session. In one or more other implementations, the first device may determine that a call state of the call session has transitioned from the hold state to a live-agent state. The first device may, in response to a determination that the call session has transitioned to the live-agent state, causing output of another notification indicating a transition to the live-agent state.

As described herein, aspects of the subject technology may include the collection and processing of privacy-sensitive data on a user’s computing device. The present disclosure contemplates that in some instances, this collected data may include personal information data that uniquely identifies or can be used to identify a specific person. Such personal information data can include demographic data, location-based data, online identifiers, telephone numbers, email addresses, voice data, audio data, video data, home addresses, images, data or records relating to a user’s health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used in providing a video voice messaging session with a transcription. Further, other uses for personal information data that benefit the user are also contemplated by the present disclosure. For instance, health and fitness data may be used, in accordance with the user’s preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of video voice messaging with transcription, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 8 illustrates an electronic system 800 with which one or more implementations of the subject technology may be implemented. The electronic system 800 can be, and/or can be a part of, the electronic device 110, the electronic device 115, the electronic device 117, the electronic device 119, the server 120 and/or the server 130 shown in FIG. 1. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a flash drive and its corresponding solid-state drive) may be used as the permanent storage device 802. Like the permanent storage device 802, the system memory 804 may be a read-and-write memory device. However, unlike the permanent storage device 802, the system memory 804 may be a volatile read-and-write memory, such as random-access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more implementations.

The bus 808 also connects to the input device interfaces 814 and output device interfaces 806. The input device interface 814 enables a user to communicate information and select commands to the electronic system 800. Input devices that may be used with the input device interface 814 may include, for example, alphanumeric keyboards and pointing devices (also called “cursor control devices”). The output device interface 806 may enable, for example, the display of images generated by electronic system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the electronic system 800 to one or more networks and/or to one or more network nodes, such as the electronic device 115 shown in FIG. 1, through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

In accordance with various aspects of the subject disclosure, a method performed by an electronic device associated with a user is provided that includes, receiving, by the electronic device, an audio signal associated with a call session; analyzing, by the electronic device, the audio signal to determine a call state of a plurality of call states of the call session; and causing output of a notification to change a user interface of the electronic device based on the determined call state.

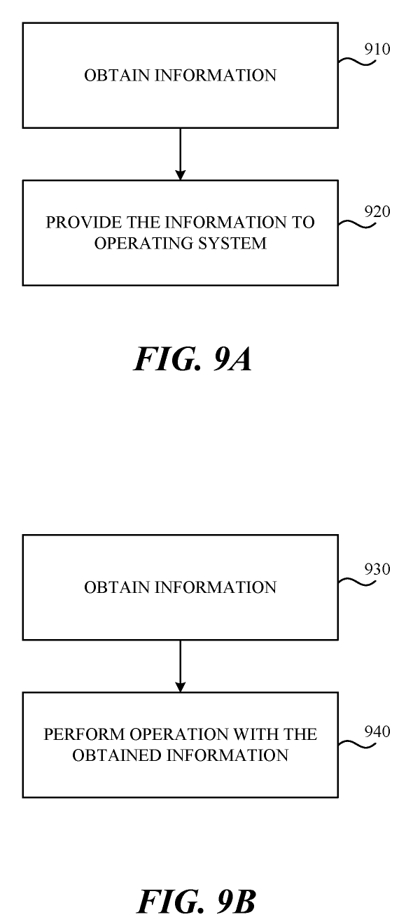

FIGS. 9A and 9B illustrate example processes for application programming interface calls in accordance with one or more implementations. Implementations within the scope of the present disclosure include a computer-readable storage medium that encodes instructions organized as an application (e.g., application 1060) that, when executed by one or more processing units, control an electronic device (e.g., device 1050) to perform the process of FIG. 9A, the process of FIG. 9B, and/or one or more other processes and/or methods described herein.

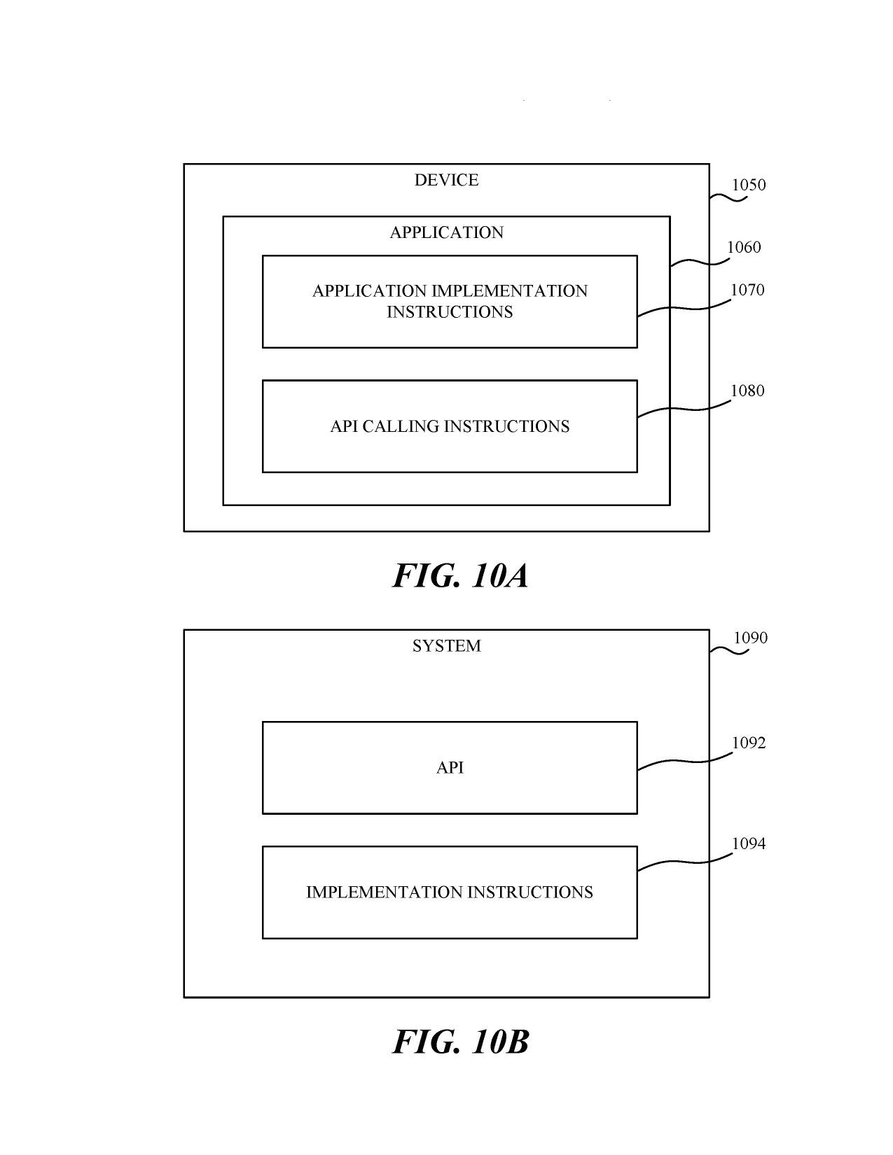

FIGS. 10A and 10B illustrate an example device and system facilitating application programming interface calls in accordance with one or more implementations. It should be recognized that application 1060 (shown in FIG. 10A) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In one or more implementations, application 1060 is an application that is pre-installed on device 1050 at purchase (e.g., a first party application). In one or more other implementations, application 1060 is an application that is provided to device 1050 via an operating system update file (e.g., a first party application or a second party application). In one or more other implementations, application 1060 is an application that is provided via an application store. In one or more implementations, the application store can be an application store that is pre-installed on device 1050 at purchase (e.g., a first party application store). In one or more other implementations, the application store is a third-party application store (e.g., an application store that is provided by another application store, downloaded via a network, and/or read from a storage device).

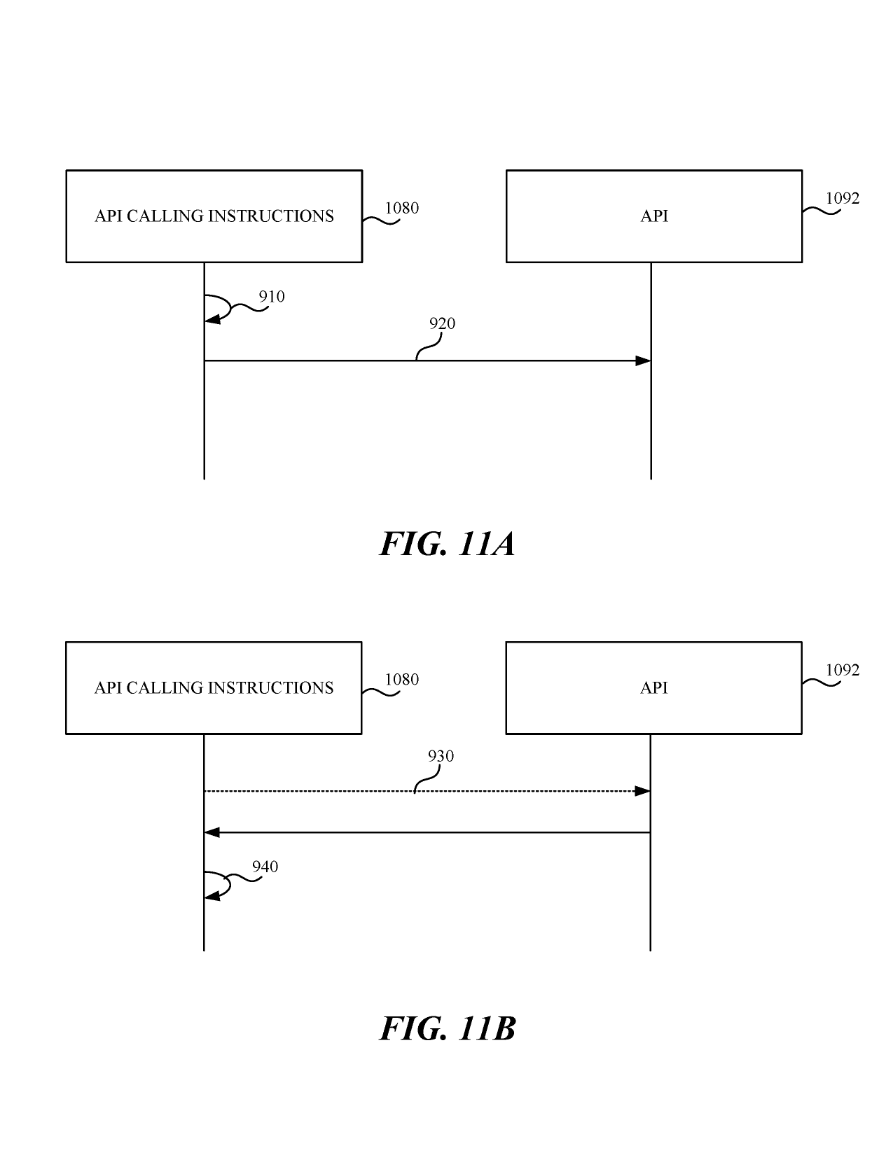

FIGS. 11A and 11B illustrate an example frame exchange facilitating application programming interface calls in accordance with one or more implementations. Referring to FIGS. 9A and 11A, application 1060 obtains information (e.g., 910). In one or more implementations, at 910, information is obtained from at least one hardware component of the device 1050. In one or more implementations, at 910, information is obtained from at least one software module (e.g., set of instructions) of the device 1050. In one or more implementations, at 910, information is obtained from at least one hardware component external to the device 1050 (e.g., a peripheral device, an accessory device, a server, etc.). In one or more implementations, the information obtained at 910 includes positional information, time information, notification information, user information, environment information, electronic device state information, weather information, media information, historical information, event information, hardware information, and/or motion information. In one or more implementations, in response to and/or after obtaining the information at 910, application 1060 provides the information to a system (e.g., 920).

In one or more implementations, the system (e.g., 1090 shown in FIG. 10B) is an operating system hosted on the device 1050. In one or more implementations, the system (e.g., 1090 shown in FIG. 10B) is an external device (e.g., a server, a peripheral device, an accessory, a personal computing device, etc.) that includes an operating system.

Referring to FIGS. 9B and 11B, application 1060 obtains information (e.g., 930). In one or more implementations, the information obtained at 930 includes positional information, time information, notification information, user information, environment information electronic device state information, weather information, media information, historical information, event information, hardware information and/or motion information. In response to and/or after obtaining the information at 930, application 1060 performs an operation with the information (e.g., 940). In one or more implementations, the operation performed at 940 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1090 based on the information.

In one or more implementations, one or more steps of the process of FIG. 9A and/or the process of FIG. 9B is performed in response to a trigger. In one or more implementations, the trigger includes detection of an event, a notification received from system 1090, a user input, and/or a response to a call to an API provided by system 1090.

In one or more implementations, the instructions of application 1060, when executed, control device 1050 to perform the process of FIG. 9A and/or the process of FIG. 9B by calling an API (e.g., API 1092) provided by system 1090. In one or more implementations, application 1060 performs at least a portion of the process of FIG. 9A and/or the process of FIG. 9B without calling API 1092.

In one or more implementations, one or more steps of the process of FIG. 9A and/or the process of FIG. 9B includes calling an API (e.g., API 1092) using one or more parameters defined by the API. In one or more implementations, the one or more parameters include a constant, a key, a data structure, an object, an object class, a variable, a data type, a pointer, an array, a list or a pointer to a function or method, and/or another way to reference a data or other item to be passed via the API.

Referring to FIG. 10A, device 1050 is illustrated. In one or more implementations, device 1050 is a personal computing device, a smart phone, a smart watch, a fitness tracker, a head mounted display (HMD) device, a media device, a communal device, a speaker, a television, and/or a tablet. In one or more other implementations, device 1050 is implemented as any one of electronic devices 110, 115, 117, 119. Device 1050 includes application 1060 and an operating system (not shown) (e.g., system 1090 shown in FIG. 10B). Application 1060 includes application implementation instructions 1070 and API calling instructions 1080. System 1090 includes API 1092 and implementation instructions 1094. It should be recognized that device 1050, application 1060, and/or system 1090 can include more, fewer, and/or different components than illustrated in FIG. 10A and 10B.

In one or more implementations, application implementation instructions 1070 is a software module that includes a set of one or more computer-executable instructions. In one or more implementations, the set of one or more instructions of instructions 1070 correspond to one or more operations performed by application 1060. For example, when application 1060 is a messaging application, application implementation instructions 1070 can include operations to receive and send messages. In one or more implementations, application implementation instructions 1070 communicates with API calling instructions to communicate with system 1090 via API 1092 (shown in FIG. 10B).

In one or more implementations, API-calling instructions 1080 is a software module that includes a set of one or more computer-executable instructions.

In one or more implementations, implementation instructions 1094 is a software module that includes a set of one or more computer-executable instructions.

In one or more implementations, API 1092 is a software module that includes a set of one or more computer-executable instructions. In one or more implementations, API 1092 provides an interface that allows a different set of instructions (e.g., API calling instructions 1080) to access and/or use one or more functions, methods, procedures, data structures, classes, and/or other services provided by implementation instructions 1094 of system 1090. For example, API-calling instructions 1080 can access a feature of implementation instructions 1094 through one or more API calls or invocations (e.g., embodied by a function or a method call) exposed by API 1092 and can pass data and/or control information using one or more parameters via the API calls or invocations. In one or more implementations, API 1092 allows application 1060 to use a service provided by a Software Development Kit (SDK) library. In one or more other implementations, application 1060 incorporates a call to a function or method provided by the SDK library and provided by API 1092 or uses data types or objects defined in the SDK library and provided by API 1092. In one or more implementations, API-calling instructions 1080 makes an API call via API 1092 to access and use a feature of implementation instructions 1094 that is specified by API 1092. In such embodiments, implementation instructions 1094 can return a value via API 1092 to API-calling instructions 1080 in response to the API call. The value can report to application 1060 the capabilities or state of a hardware component of device 1050, including those related to aspects such as input capabilities and state, output capabilities and state, processing capability, power state, storage capacity and state, and/or communications capability. In one or more implementations, API 1092 is implemented in part by firmware, microcode, or other low-level logic that executes in part on the hardware component.

In one or more implementations, API 1092 allows a developer of API-calling instructions 1080 (which can be a third-party developer) to leverage a feature provided by implementation instructions 1094. In such embodiments, there can be one or more set of API-calling instructions (e.g., including API-calling instructions 1080) that communicate with implementation instructions 1094. In one or more implementations, API 1092 allows multiple sets of API-calling instructions written in different programming languages to communicate with implementation instructions 1094 (e.g., API 1092 can include features for translating calls and returns between implementation instructions 1094 and API-calling instructions 1080) while API 1092 is implemented in terms of a specific programming language. In one or more implementations, API-calling instructions 1080 calls APIs from different providers such as a set of APIs from an OS provider, another set of APIs from a plug-in provider, and/or another set of APIs from another provider (e.g., the provider of a software library) or creator of the another set of APIs.

Examples of API 1092 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In one or more implementations the sensor API is an API for accessing data associated with a sensor of device 1050. For example, the sensor API can provide access to raw sensor data. For another example, the sensor API can provide data derived (and/or generated) from the raw sensor data. In one or more implementations, the sensor data includes temperature data, image data, video data, audio data, heart rate data, IMU (inertial measurement unit) data, lidar data, location data, GPS data, and/or camera data. In one or more implementations, the sensor includes one or more of an accelerometer, temperature sensor, infrared sensor, optical sensor, heartrate sensor, barometer, gyroscope, proximity sensor, temperature sensor and/or biometric sensor.

In one or more implementations, implementation instructions 1094 is a system (e.g., operating system, server system) software module (e.g., a collection of computer-readable instructions) that is constructed to perform an operation in response to receiving an API call via API 1092. In one or more implementations, implementation instructions 1094 is constructed to provide an API response (via API 1092) as a result of processing an API call. By way of example, implementation instructions 1094 and API-calling instructions 1080 can each be any one of an operating system, a library, a device driver, an API, an application program, or other module. It should be understood that implementation instructions 1094 and API-calling instructions 1080 can be the same or different type of software module from each other. In one or more implementations, implementation instructions 1094 is embodied at least in part in firmware, microcode, or other hardware logic.

In one or more implementations, implementation instructions 1094 returns a value through API 1092 in response to an API call from API-calling instructions 1080. While API 1092 defines the syntax and result of an API call (e.g., how to invoke the API call and what the API call does), API 1092 might not reveal how implementation instructions 1094 accomplishes the function specified by the API call. Various API calls are transferred via the one or more application programming interfaces between API-calling instructions 1080 and implementation instructions 1094. Transferring the API calls can include issuing, initiating, invoking, calling, receiving, returning, and/or responding to the function calls or messages. In other words, transferring can describe actions by either of API-calling instructions 1080 or implementation instructions 1094. In one or more implementations, a function call or other invocation of API 1092 sends and/or receives one or more parameters through a parameter list or other structure.

In one or more implementations, implementation instructions 1094 provides more than one API, each providing a different view of or with different aspects of functionality implemented by implementation instructions 1094. For example, one API of implementation instructions 1094 can provide a first set of functions and can be exposed to third-party developers, and another API of implementation instructions 1094 can be hidden (e.g., not exposed) and provide a subset of the first set of functions and also provide another set of functions, such as testing or debugging functions which are not in the first set of functions. In one or more implementations, implementation instructions 1094 calls one or more other components via an underlying API and thus be both a set of API calling instructions and a set of implementation instructions. It should be recognized that implementation instructions 1094 can include additional functions, methods, classes, data structures, and/or other features that are not specified through API 1092 and are not available to API calling instructions 1080. It should also be recognized that API calling instructions 1080 can be on the same system as implementation instructions 1094 or can be located remotely and access implementation instructions 1094 using API 1092 over a network. In one or more implementations, implementation instructions 1094, API 1092, and/or API-calling instructions 1080 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An API is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected, the direct sensor data (e.g., data representing or corresponding to detection of the input) is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls made between steps of interacting with the computer system (e.g., API calls between different software components of the computer system or between a software component of the computer system and a software component of one or more remote computer systems).

In one or more implementations, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In one or more implementations, the application is an application that is pre-installed on the first computer system at purchase (e.g., a first party application). In one or more other implementations, the application is an application that is provided to the first computer system via an operating system update file (e.g., a first party application). In one or more other implementations, the application is an application that is provided via an application store. In some implementations, the application store is pre-installed on the first computer system at purchase (e.g., a first party application store) and allows download of one or more applications. In one or more implementations, the application store is a third-party application store (e.g., an application store that is provided by another device, downloaded via a network, and/or read from a storage device). In one or more implementations, the application is a third-party application (e.g., an app that is provided by an application store, downloaded via a network, and/or read from a storage device).

In one or more implementations, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In one or more other implementations, exemplary APIs also include one or more of: a digital assistant API, a text assistant API, a generative runtime environment API, a text model inference API, a diffusion model inference API, a cloud LLM inference API, a proofreading API, a rewrite API, a smart reply API, and/or a third-party API.

In one or more implementations, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters (e.g., adapter weights) that are passed between the API calling instructions and the implementation instructions. In one or more implementations, the API 1092 defines a first API call response that can be provided to the application by API calling instructions 1080. In one or more implementations, the set of implementation instructions is a system software module (e.g., a collection of computer-readable instructions) that is constructed to perform an operation in response to receiving an API call via the API. In one or more implementations, the set of implementation instructions is constructed to provide an API response (via the API) as a result of processing an API call. In one or more implementations, the set of implementation instructions is included in the device (e.g., 1050) that runs the application. In one or more implementations, the set of implementation instructions is included in an electronic device that is separate from the device that runs the application.

In accordance with various aspects of the subject disclosure, an electronic device for analyzing an audio signal is provided that includes a memory and one or more processors configured to, determine, based on analysis of an audio signal associated with a call session corresponding to a telephony application, that a call state of the call session corresponds to a hold state; and based on determining that the call state corresponds to the hold state, initiating a transition from a user interface corresponding to the telephony application based on the hold state.

In accordance with various aspects of the subject disclosure, a non-transitory computer-readable medium is provided that includes instructions, which when executed by one or more processors, cause the one or more processors to perform operations that include, determining, based on analysis of an audio signal associated with a call session, that a call state of the call session has transitioned from a hold state to a live-agent state; and causing output of a notification signal to a user indicating a transition to the live-agent state.

In accordance with various aspects of the subject disclosure, a method performed by an electronic device is provided that includes, receiving a telephone number associated with a call session; querying, by the electronic device, a database comprising records of obfuscated telephone numbers previously identified as initiating hold states in call sessions; determining, based on a match between the telephone number associated with the call session and at least one of the obfuscated telephone numbers, that the call session is likely to enter a hold state; and causing output of a notification to change a user interface of the electronic device based on the call session being predicted to transition into the hold state.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the call hold assist processes can be used to benefit users. For example, the data can be used to train models that can be deployed to improve performance, accuracy, and/or functionality of applications and/or services. Accordingly, the use of the data enables the call hold assist processes to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the call hold assist processes are also contemplated by the present disclosure.

The present disclosure contemplates that, in some embodiments, data used by call hold assist processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with call hold assist processes, should attempt to comply with well-established privacy policies and/or privacy practices.

For example, such entities may implement and consistently follow policies and practices recognized as meeting or exceeding industry standards and regulatory requirements for developing and/or training call hold assist processes. In doing so, attempts should be made to ensure all intellectual property rights and privacy considerations are maintained. Training should include practices safeguarding training data, such as personal information, through sufficient protections against misuse or exploitation. Such policies and practices should cover all stages of the call hold assist processes development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, call hold assist processes may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for call hold assist processes may be kept strictly separated from platforms where the call hold assist processes are deployed and/or used to interact with users and/or process data. In such embodiments, data used for offline training of the call hold assist processes may be maintained in secured datastores with restricted access and/or not be retained beyond the duration necessary for training purposes. In some embodiments, the call hold assist processes may utilize a local memory cache to store data temporarily during a user session. The local memory cache may be used to improve performance of the call hold assist processes. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the call hold assist processes. The call hold assist processes should be monitored for changes in underlying data distribution such as concept drift or data skew that can degrade performance of the call hold assist processes over time.

In some embodiments, the call hold assist processes are trained using a combination of offline and online training. Offline training can use curated datasets to establish baseline model performance, while online training can allow the call hold assist processes to continually adapt and/or improve. The present disclosure recognizes the importance of maintaining strict data governance practices throughout this process to ensure user privacy is protected.

In some embodiments, the call hold assist processes may be designed with safeguards to maintain adherence to originally intended purposes, even as the call hold assist processes adapt based on new data. Any significant changes in data collection and/or applications of call hold assist process use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the call hold assist processes and/or for use as input during the inference stage of such systems. In yet another example, the present technology should be configured to allow users to be able to select to limit the length of time data is maintained or entirely prohibit the use of their data for use by the call hold assist processes. In addition to providing “opt in” and “opt out” options, the present disclosure contemplates providing notifications relating to the access or use of personal information. For instance, a user can be notified when their data is being input into the call hold assist processes for training or inference purposes, and/or reminded when the call hold assist processes generate outputs or make decisions based on their data.

The present disclosure recognizes call hold assist processes should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to or failures to cite third-party products and/or services in the outputs should not be construed as endorsements or affiliations by the entities providing the call hold assist processes. Generated content can be filtered for potentially inappropriate or dangerous material prior to being presented to users, while human oversight and/or ability to override or correct erroneous or undesirable outputs can be maintained as a failsafe.

The present disclosure further contemplates that users of the call hold assist processes should refrain from using the services in any manner that infringes upon, misappropriates, or violates the rights of any party. Furthermore, the call hold assist processes should not be used for any unlawful or illegal activity, nor to develop any application or use case that would commit or facilitate the commission of a crime, or other tortious, unlawful, or illegal act including misinformation, disinformation, misrepresentations (e.g., deepfakes), deception, impersonation, and propaganda. The call hold assist processes should not violate, misappropriate, or infringe any copyrights, trademarks, rights of privacy and publicity, trade secrets, patents, or other proprietary or legal rights of any party, and appropriately attribute content as required. Further, the call hold assist processes should not interfere with any security, digital signing, digital rights management, content protection, verification, or authentication mechanisms. The call hold assist processes should not misrepresent machine-generated outputs as being human-generated.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the phrase “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method performed by an electronic device associated with a user, the method comprising:
receiving, by the electronic device, an audio signal associated with a call session;
analyzing, by the electronic device, the audio signal to determine a call state of a plurality of call states of the call session; and
causing output of a notification to change a user interface of the electronic device based on the determined call state.

2. The method of claim 1, wherein analyzing the audio signal comprises transcribing spoken language in the audio signal into a transcribed text and classifying the transcribed text using a machine learning classifier executed by the electronic device.

3. The method of claim 2, wherein the machine learning classifier is configured to determine whether the spoken language is a pre-recorded message or speech uttered by a human agent.

4. The method of claim 2, wherein the machine learning classifier performs classification at a word-level granularity to enable accelerated state determination.

5. The method of claim 1, wherein analyzing the audio signal comprises:
evaluating successive periods of audio waveforms of the call session to detect an audio pattern comprising at least one of music or silence; and
identifying the call state as a hold state based on the audio pattern.

6. The method of claim 1, wherein analyzing the audio signal comprises:
detecting user input via one or more interactions with a keypad of the electronic device;
analyzing the one or more interactions with the keypad; and
determining that the user input is indicative of the user of the electronic device engaging with an automated call tree in the call session, wherein the call state is determined during traversal of at least in part the automated call tree.

7. The method of claim 1, further comprising:
accessing, by the electronic device, a plurality of language-specific language models stored in memory of the electronic device;
selecting, prior to initiation of the call session, at least one of the plurality of language-specific language models based on user-configured language settings; and
executing the selected at least one of the plurality of language-specific language models for real-time processing of speech data during the call session.

8. An electronic device for analyzing an audio signal, the electronic device comprising:
memory; and
at least one processor configured to:
determine, based on analysis of an audio signal associated with a call session corresponding to a telephony application, that a call state of the call session corresponds to a hold state; and
based on determining that the call state corresponds to the hold state, initiating a transition from a user interface corresponding to the telephony application based on the hold state.

9. The electronic device of claim 8, wherein the at least one processor configured to initiate the transition is further configured to prompt a user to perform at least one of minimizing a screen display of the telephony application running on the electronic device or silencing an audio output associated with the call session.

10. The electronic device of claim 8, wherein the at least one processor configured to initiate the transition is further configured to disable a subset of user interface elements associated with the call session until a transition from the hold state to a live-agent state is detected.

11. A non-transitory computer-readable medium storing instructions that, when executed by one or more processors of an electronic device, cause the electronic device to:
determine, based on analysis of an audio signal associated with a call session, that a call state of the call session has transitioned from a hold state to a live-agent state; and
cause output of a notification signal to a user indicating a transition to the live-agent state.

12. The non-transitory computer-readable medium of claim 11, wherein the notification signal is output to one or more secondary electronic devices associated with the user that are located within a predefined proximity of the electronic device.

13. The non-transitory computer-readable medium of claim 11, wherein the user ceases participation in the call session during at least in part the hold state, and wherein the notification signal comprises an audio message transmitted via an uplink channel to a remote agent endpoint, the audio message indicating that the user is returning to the call session.

14. The non-transitory computer-readable medium of claim 11, wherein the instructions that cause the electronic device to determine the transition to the live-agent state, which when executed by the one or more processors, further cause the electronic device to:
transcribe speech within the audio signal;
classify the transcribed speech using a machine learning classifier trained to distinguish human agents from automated messages; and
identify the call state as the live-agent state based on output of the machine learning classifier.

15. The non-transitory computer-readable medium of claim 11, wherein the instructions, which when executed by the one or more processors, further cause the electronic device to:
access a database of obfuscated telephone numbers; and
determine a predicted hold state based on querying the database using an obfuscated telephone number associated with the call session.

16. The non-transitory computer-readable medium of claim 11, wherein the instructions that cause the electronic device to determine the transition to the live-agent state, which when executed by the one or more processors, further cause the electronic device to inject uplink audio indicating to a remote agent that the user is returning to the call session.

17. A method performed by an electronic device, the method comprising:
receiving a telephone number associated with a call session;
querying, by the electronic device, a database comprising records of obfuscated telephone numbers previously identified as initiating hold states in call sessions;
determining, based on a match between the telephone number associated with the call session and at least one of the obfuscated telephone numbers, that the call session is likely to enter a hold state; and
causing output of a notification to change a user interface of the electronic device based on the call session being predicted to transition into the hold state.

18. The method of claim 17, wherein the database is constructed over time by storing obfuscated telephone numbers associated with detected hold conditions.

19. The method of claim 17, further comprising, in response to a determination that the call session is in the hold state, causing a transition of presentation on the electronic device, the transition comprising at least one of silencing audio output of the call session or minimizing a call interface associated with the call session.

20. The method of claim 17, further comprising:
determining that a call state of the call session has transitioned from the hold state to a live-agent state; and
in response to a determination that the call session has transitioned to the live-agent state, causing output of another notification indicating a transition to the live-agent state.
